(19) United States
(12) Patent Application Publication
(10) Pub. No.: US 2026/0216705 A1
(43) Pub. Date: Jul. 30, 2026

(54) Supported Catalyst for Manufacturing Carbon Nanotubes, Carbon Nanotubes, and Manufacturing Method Thereof

(71) Applicant: SK Innovations Co., Ltd., Seoul (KR)

(72) Inventors: Young Kwang Kim, Daejeon (KR); Soo Bean Kim, Daejeon (KR); Hyun Suk Chung, Daejeon (KR); Yong Bin Han, Daejeon (KR)

(21) Appl. No.: 19/003,009

(22) Filed: Dec. 27, 2024

(30) Foreign Application Priority Data
Jan. 3, 2024 (KR) 10-2024-0000760

(51) Int. Cl. B01J 23/847; B01J 21/04; B01J 35/40; B01J 35/54; B01J 35/61; B01J 37/02; B01J 37/08; C01B 32/162

(52) U.S. Cl. CPC B01J 23/8472; B01J 21/04; B01J 35/40; B01J 35/54; B01J 35/612; B01J 35/613; B01J 37/0221; B01J 37/08; C01B 32/162; C01B 2202/34; C01P 2004/03; C01P 2004/13

(57) ABSTRACT

A supported catalyst for manufacturing carbon nanotubes according to the present disclosure includes a plate-shaped carrier and a plurality of metal catalyst particles which are attached to a surface of the plate-shaped carrier and include cobalt and vanadium. A method for manufacturing carbon nanotubes according to the present disclosure includes preparing a mixture comprising a metal precursor and a polymer gel, preparing a plate-shaped carrier by calcining the mixture, preparing a supported catalyst by attaching a plurality of metal catalyst particles comprising cobalt and vanadium to the surface of the plate-shaped carrier, and manufacturing a carbon nanotube by bringing the supported catalyst into contact with a carbon source. The carbon nanotube according to the present disclosure has an average straightness of 0.8 or more.

### CROSS-REFERENCE TO RELATED APPLICATION

This application claims priority to Korean Patent Application No. 10-2024-0000760 filed Jan. 3, 2024, the disclosure of which is hereby incorporated by reference in its entirety.

### BACKGROUND

### Technical Field

The present disclosure relates to a supported catalyst for manufacturing carbon nanotubes, carbon nanotubes, and a manufacturing method thereof.

### Technical Considerations

Carbon nanotubes (CNTs) are materials used in many fields due to their excellent chemical stability and mechanical properties, as well as high thermal conductivity.

Depending on synthesis conditions, the carbon nanotubes are classified into: single-walled carbon nanotubes having a structure made by rolling up one layer of graphite and connecting ends thereof; double-walled carbon nanotubes having a shape in which two layers of the single-walled carbon nanotubes are arranged about a concentric axis; and multi-walled carbon nanotubes composed of a plurality of single-walled carbon nanotubes in a multi-layer.

Since the carbon nanotubes are composed of a graphite structure, free electrons may move along the surface of the carbon nanotubes, and the carbon nanotubes may have high electrical conductivity. Accordingly, the carbon nanotubes may be applied to various fields that require electrical properties such as antistatic, electromagnetic shielding, heat dissipation and the like. When individual carbon nanotubes are arranged or oriented in a constant direction, they may have higher electrical conductivity, and the closer the shape of the carbon nanotube is to a straight line, the higher the electrical conductivity they can have.

The carbon nanotubes also have high electric attraction, and therefore are generally obtained in an entangled type in which individual carbon nanotubes are entangled. The individual carbon nanotubes separated from the entangled carbon nanotubes may be bent in a zigzag shape, and have low electrical conductivity. Accordingly, a method for manufacturing carbon nanotubes having high electrical conductivity is required.

### SUMMARY

An object of the present disclosure is to provide a supported catalyst for manufacturing carbon nanotubes, which is capable of providing carbon nanotubes having improved quality.

In addition, another object of the present disclosure is to provide carbon nanotubes having improved quality.

Further, another object of the present disclosure is to provide a method for manufacturing carbon nanotubes having improved quality.

One or more of the above objects may be achieved by one or more of the embodiments disclosed herein.

In some non-limiting embodiments or aspects of the present disclosure, provided is a supported catalyst for manufacturing carbon nanotubes comprising: a plate-shaped carrier; and a plurality of metal catalyst particles which are attached to a surface of the plate-shaped carrier and comprise cobalt and vanadium.

According to some embodiments, the plate-shaped carrier may comprise an aluminum oxide.

According to some embodiments, the plate-shaped carrier may have a thickness of 80 nm to 150 nm.

According to some embodiments, the plate-shaped carrier may have a median particle diameter (D50) of 15 μm to 30 μm.

According to some embodiments, the plate-shaped carrier may have a BET surface area of 5 m²/g to 50 m²/g.

According to some embodiments, a content of the metal catalyst particles based on a total weight of the supported catalyst may be 10% by weight to 30% by weight.

According to some embodiments, a ratio of the vanadium content to the cobalt content based on a total moles of the metal catalyst particles may be more than 0 and 0.5 or less.

According to some embodiments, a ratio of the vanadium content to the cobalt content based on a total moles of the metal catalyst particles may be 0.05 to 0.25.

According to some non-limiting embodiments or aspects of the present disclosure, provided is a method for manufacturing carbon nanotubes, comprising: preparing a mixture comprising a metal precursor and a polymer gel; preparing a plate-shaped carrier by calcining the mixture; preparing a supported catalyst by attaching a plurality of metal catalyst particles comprising cobalt and vanadium to a surface of the plate-shaped carrier; and manufacturing carbon nanotubes by bringing the supported catalyst into contact with a carbon source.

According to some embodiments, the calcination may be performed at a temperature of 500° C. to 1,000° C.

According to some embodiments, a carbon source conversion ratio defined as a percentage of a total weight of the carbon nanotube to a total weight of the carbon source may be 50% to 90%.

According to some non-limiting embodiments or aspects of the present disclosure, provided is a carbon nanotube having an average straightness of 0.8 or more, which is represented by Equation 1 below:

$$Average straightness = \frac{{\sum }_{k = 1}^{n} {L}_{k} / {V}_{sum , k}}{n} \qquad [ Equation 1 ]$$

(in Equation 1, n is an integer of 10 to 100, Lₖ is a distance formed by connecting opposite endpoints of any single carbon nanotube in a straight line from an SEM image of the carbon nanotube, and V_{sum,k} means a sum of lengths of 5 to 20 two-dimensional vectors connected to each other along a shape of the single carbon nanotube when forming the respective 5 to 20 number of the two-dimensional vectors between the opposite endpoints of the single carbon nanotube from the SEM image).

According to some embodiments, the carbon nanotube may have at least one bending part.

The supported catalyst for manufacturing carbon nanotubes according to some embodiments of the present disclosure may provide carbon nanotubes having a linear-like shape. Accordingly, orientation of the carbon nanotubes may be improved, and free electrons may move smoothly on the surface of the carbon nanotubes, thereby improving the electrical conductivity of the carbon nanotubes.

The supported catalyst for manufacturing carbon nanotubes according to some embodiments of the present disclosure may provide high-purity carbon nanotubes at a high yield.

The carbon nanotubes according to some embodiments of the present disclosure may have a linear-like shape, thus to have high orientation.

### BRIEF DESCRIPTION OF THE DRAWINGS

The above and other objects, features and other advantages of the present disclosure will be more clearly understood from the following detailed description taken in conjunction with the accompanying drawings, in which:

FIG. 1 is a schematic view illustrating a cross-section of an exemplary supported catalyst for manufacturing carbon nanotubes according to the principles of the present disclosure;

FIG. 2 is a schematic flowchart illustrating sequences of an exemplary method for manufacturing carbon nanotubes according to the principles of the present disclosure;

FIG. 3 is a particle size distribution graph of plate-shaped carriers of preparative examples according to the principles of the present disclosure;

FIGS. 4 and 5 are SEM images of plate-shaped carriers of Preparative Example 1;

FIG. 6 is an SEM image of carbon nanotubes of Example 2;

FIG. 7A is an enlarged view of a dotted line portion in FIG. 6; and

FIG. 7B is a schematic view for describing a method for calculating the straightness of carbon nanotubes shown in FIG. 7A.

### DETAILED DESCRIPTION

The present disclosure provides a supported catalyst for manufacturing carbon nanotubes comprising a plate-shaped carrier. In addition, the present disclosure provides a method for manufacturing carbon nanotubes using the supported catalyst for manufacturing carbon nanotubes, and carbon nanotubes manufactured by the same.

Hereinafter, the present disclosure will be described in detail through embodiments with reference to the accompanying drawings. However, the embodiments are merely illustrative and the present disclosure is not limited to the specific embodiments described by way of example.

Furthermore, throughout the disclosure, unless otherwise particularly stated, the word “comprise”, “include”, “contain”, or “have” does not mean the exclusion of any other constituent element, but means further inclusion of other constituent elements, and elements, materials, or processes which are not further listed are not excluded.

Unless the context clearly indicates otherwise, the singular forms of the terms used in the present specification may be interpreted as including the plural forms. As used herein, the singular form of “a”, “an”, and “the” include plural referents unless the context clearly states otherwise.

The numerical range used in the present disclosure comprises all values within the range comprising the lower limit and the upper limit, increments logically derived in a form and spanning in a defined range, all double limited values, and all possible combinations of the upper limit and the lower limit in the numerical range defined in different forms. As an example, when it is defined that a content of a composition is 10% to 80% or 20% to 50%, it should be interpreted that a numerical range of 10% to 50% or 50% to 80% is also described in the specification of the present disclosure. Unless otherwise defined in the present disclosure, values which may be outside a numerical range due to experimental error or rounding off of a value are also comprised in the defined numerical range.

For the purposes of this disclosure, unless otherwise indicated, all numbers expressing quantities of ingredients, reaction conditions, dimensions, physical characteristics, and so forth used in the disclosure are to be understood as being modified in all instances by the term “about.” Hereinafter, unless otherwise particularly defined in the present disclosure, “about” may be considered as a value within 30%, 25%, 20%, 15%, 10%, 5%, 3%, 2%, 1%, 0.5%, 0.1%, 0.05% or 0.01% of a stated value. Unless indicated to the contrary, the numerical parameters set forth in this disclosure are approximations that can vary depending upon the desired properties sought to be obtained by the present invention.

Notwithstanding that the numerical ranges and parameters setting forth the broad scope of the invention are approximations, the numerical values set forth in the specific examples are reported as precisely as possible. Any numerical value, however, inherently contains certain errors necessarily resulting from the standard deviation found in their respective testing measurements.

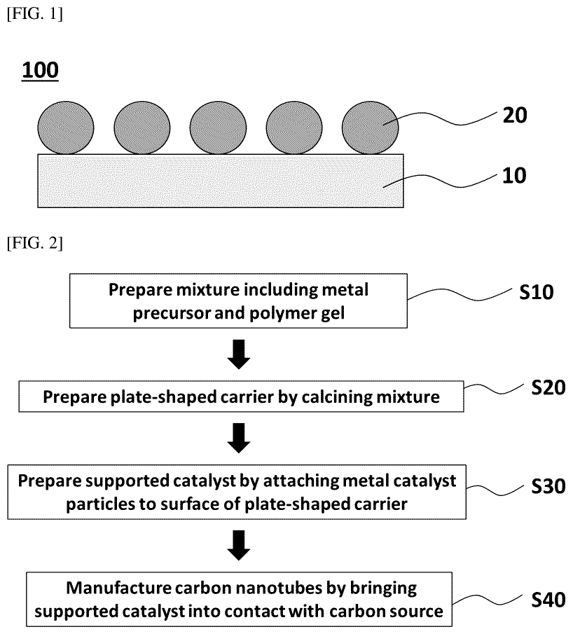

FIG. 1 is a schematic view illustrating a cross-section of a non-limiting embodiment or aspect of a supported catalyst for manufacturing carbon nanotubes. Referring to FIG. 1, a supported catalyst 100 for manufacturing carbon nanotubes comprises a plate-shaped carrier 10 and a plurality of metal catalyst particles 20.

In some embodiments, the plate-shaped carrier 10 may have sizes in a longitudinal direction and a width direction, which are longer than a size in a thickness direction. The thickness direction may be a direction perpendicular to the longitudinal direction and the width direction. Accordingly, in some embodiments, the plate-shaped carrier 10 may have a platelet shape.

In some embodiments, the plate-shaped carrier 10 may have a thickness of 80 nm to 150 nm. In some embodiments, a longer one of the lengths in the longitudinal direction and the width direction of the plate-shaped carrier 10 may be 15 μm to 30 μm.

According to some embodiments, the plate-shaped carrier 10 may have a median particle diameter (D50) of 15 μm to 30 μm. According to some embodiments, the plate-shaped carrier 10 may have a median particle diameter (D50) of 20 μm to 28 μm.

The particle diameter of the plate-shaped carrier may mean the maximum size on a surface defined in the longitudinal direction or the width direction of the plate-shaped carrier. The median particle diameter (D50) means a particle diameter at a point where the cumulative volume distribution percentage of the particles reaches 50%. The cumulative volume distribution may be obtained, for example, by a laser particle size analyzer (e.g., LA-950V2/Horiba).

In some embodiments, an average of values obtained by dividing an area of the plate-shaped carrier 10 by the thickness of the plate-shaped carrier 10 may be 3,000 μm to 7,000 μm. In some embodiments, the average of values obtained by dividing an area of the plate-shaped carrier 10 by the thickness of the plate-shaped carrier 10 may be 4,000 μm to 6,500 μm. The “area” may mean an area of the plate-shaped carrier 10 defined in the longitudinal direction and the width direction.

According to some embodiments, the plate-shaped carrier 10 may have a BET surface area of 5 m²/g to 50 m²/g. According to some embodiments, the plate-shaped carrier 10 may have a BET surface area of 5 m²/g to 25 m²/g. The BET surface area may mean a nitrogen adsorption surface area measured using the Brunauer-Emmett-Teller (BET) method. The method of measuring the BET surface area is not particularly limited, but may be measured using, for example, Micromeritics/3Flex.

For example, the BET surface area may be measured by the following method. After filling a BET cell with 0.1 g of the plate-shaped carriers, by heating the cell at 150° C. in a vacuum state, the moisture may be removed. After measuring a weight of the plate-shaped carriers from which the moisture has been removed, an amount of nitrogen adsorbed on a sample may be measured while injecting nitrogen. After stopping the injection of nitrogen, an inside of the BET cell is made to the vacuum state again, an amount of nitrogen desorbed from the sample may be measured, and the BET surface area of the plate-shaped carriers may be calculated using the measurements.

The plate-shaped carrier 10 having a BET surface area within the above range may have a surface area of a width suitable for the metal catalyst particles 20 are attached.

In some embodiments, the plate-shaped carrier 10 may comprise a metal oxide. The metal oxide may be a ceramic component which does not react with a carbon source. For example, the metal oxide may comprise an aluminum oxide.

The metal catalyst particles 20 comprise cobalt (Co) and vanadium (V). Cobalt may function as a main catalyst for a reaction of converting the carbon source into carbon nanotubes, and vanadium may function as a cocatalyst for assisting the function of cobalt as the main catalyst.

The metal catalyst particles 20 may further comprise other metals in addition to the cobalt and vanadium. For example, the metal catalyst particles 20 may further comprise iron, nickel and/or the like.

According to some embodiments, a ratio of the vanadium content to the cobalt content based on the total moles of the metals comprised in the metal catalyst particles 20 may be greater than 0 and 0.5 or less. According to some embodiments, the ratio of the vanadium content to the cobalt content based on the total moles of the metals comprised in the metal catalyst particles 20 may be 0.05 to 0.25 or 0.1 to 0.25. For example, the ratio of vanadium content to the cobalt content based on the total moles of the metals can be 5:95, or 10:90, or 15:85; or 20:80; or 25:75, or 30:70, or 35:65, or 40:60, or 45:55, or less than 50:more than 50.

Within the above range, carbon nanotubes having a higher purity and a shape more similar to a straight line may be manufactured.

According to some embodiments, a content of the metal catalyst particles 20 based on a total weight of the supported catalyst 100 may be 10% by weight (“wt. %”) to 30 wt. %. According to some embodiments, the content of the metal catalyst particles 20 based on the total weight of the supported catalyst 100 may be 10 wt. % to 25 wt. %, or 15 wt. % to 20 wt. %.

Within the above range, carbon nanotubes having a higher purity and a shape more similar to a straight line may be manufactured.

According to some embodiments, the metal catalyst particles 20 may have a median particle diameter (D50) of 50 nm to 150 nm. According to some embodiments, the metal catalyst particles 20 may have a median particle diameter (D50) of 80 nm to 120 nm. Within the above range, carbon nanotubes having a sufficiently large number of surface active points where the carbon nanotubes can grow, as well as having an appropriate length may be manufactured.

According to the present disclosure, a method for manufacturing carbon nanotubes is provided. FIG. 2 is a schematic flowchart illustrating sequences of a non-limiting embodiment or aspect of a method for manufacturing carbon nanotubes. Hereinafter, each step of the method will be described in detail with reference to the drawings.

First, a mixture comprising a metal precursor and a polymer gel is prepared (for example, S10 in FIG. 2). The metal precursor may be a compound of metals comprised in the metal oxide of the plate-shaped carrier. The polymer gel may act as a template so that the metal precursor can be formed in a platelet shape.

The metal precursor may comprise, for example, a metal nitride, a metal hydroxide, and/or a metal sulfide, etc. For example, the metal precursor may be an aluminum precursor. For example, the aluminum precursor may be aluminum nitrate.

The polymer gel may be a polymer hydrogel. For example, the polymer gel may be prepared by mixing a hydrophilic polymer and water. The hydrophilic polymer may comprise, for example, polyvinyl alcohol, polyvinylacetate, polyvinyl butyral, polyethylene glycol, polyvinylpyrrolidone, polyacrylonitrile, polytetrafluoroethylene, ethylene glycol, and/or diethylene glycol, etc. These may be used alone or in combination of two or more thereof.

In some embodiments, the polymer gel may be prepared by mixing 300 to 1,000 parts by weight (“wt. parts”) of water based on 100 wt. parts of the hydrophilic polymer. In this case, the mixing may be performed at a temperature of about 80° C. to 95° C.

In some embodiments, a content of the metal precursor may be 30 to 70 wt. parts based on 100 wt. parts of the polymer gel.

The mixture comprising the metal precursor and the polymer gel may further comprise other components. For example, the mixture may further comprise water to dissolve the metal precursor, and may further comprise a compound which allows the metal oxide formed from the metal precursor to have an appropriate surface area, porosity, and low density.

The compound may comprise, for example, glycine, proline, glutamic acid, serine, theanine, methionine, valine, leucine, L-aspartic acid, and/or glutathione, etc. These may be used alone or in combination of two or more thereof.

Then, a plate-shaped carrier is prepared by calcining the mixture (for example, S20 in FIG. 2). As the polymer gel of an organic component is removed by the calcination, the plate-shaped carrier may be formed.

According to some embodiments, the calcination may be performed by inputting the mixture into a heating furnace, increasing the temperature at a heating rate of about 2 to 10° C./min, and maintaining the temperature when reaching the calcination temperature.

According to some embodiments, the calcination may be performed at a temperature of 500° C. to 1,000° C. According to some embodiments, the calcination may be performed at a temperature of 600° C. to 900° C. or 700° C. to 850° C. Within the above range, a plate-shaped carrier having an appropriate thickness may be formed.

The calcination may be performed for about 3 hours to 10 hours or 4 hours to 6 hours, and may be performed in an air atmosphere. Accordingly, a plate-shaped carrier comprising the metal oxide may be formed.

Next, a supported catalyst is prepared by attaching a plurality of metal catalyst particles to the surface of the plate-shaped carrier (for example, S30 in FIG. 2). The metal catalyst particles comprise cobalt and vanadium, wherein details of the metal catalyst particles may be the same as the above description.

According to some embodiments, the plate-shaped carrier and the plurality of metal catalyst particles are mixed, and then calcined to manufacture the supported catalyst. For example, the calcination may be performed at a temperature of 500° C. to 1,000° C.

Next, a carbon nanotube is manufactured by bringing the supported catalyst into contact with the carbon source (for example, S40 in FIG. 2). The manufacturing may be performed in a batch reactor or a continuous reactor.

For example, the carbon nanotubes may be manufactured by inputting the supported catalyst into the batch reactor, and injecting a mixed gas comprising a carbon source into the reactor. The carbon source may be a gaseous hydrocarbon compound, and the mixed gas may comprise the carbon source and hydrogen. A mixing ratio of the carbon source and hydrogen is not particularly limited, but may be, for example, 25:75 to 75:25 in a volume ratio.

According to some embodiments, the carbon nanotubes may be manufactured by bringing the supported catalyst into contact with the carbon source, and then performing a reaction at a temperature of about 500° C. to 1,000° C. for 10 to 100 minutes.

According to some embodiments, a carbon source conversion ratio, which is defined as a percentage of a total weight of the carbon nanotubes to a total weight of the carbon source, may be 50% to 90%. According to some embodiments, the carbon source conversion ratio, which is defined as a percentage of the total weight of the carbon nanotubes to the total weight of the carbon source, may be 60% to 90%. The higher the carbon source conversion ratio, the better the productivity of the carbon nanotubes.

According to some embodiments, a carbon nanotube production efficiency of the supported catalyst for manufacturing carbon nanotubes may be 10 g_{CNT}/g_{CAL} to 32 g_{CNT}/g_{CAL}. According to some embodiments, the carbon nanotube production efficiency of the supported catalyst for manufacturing carbon nanotubes may be 25 g_{CNT}/g_{CAL} to 32 g_{CNT}/g_{CAL}.

The carbon nanotube production efficiency may be defined as a ratio of the total weight of the carbon nanotube to the total weight of the supported catalyst. For example, when an input amount of the supported catalyst is about 1 g and a yield of the carbon nanotube is about 15 g, the carbon nanotube production efficiency of the supported catalyst may be about 15 g_{CNT}/g_{CAL}.

For example, the production efficiency may be calculated based on the weight of the carbon nanotube produced when about 37.5 g of the carbon source was input while using 1 g of the supported catalyst, and the reaction was performed at a temperature of about 700° C.

The carbon nanotube according to the present disclosure has an average straightness of 0.8 or more, which is represented by Equation 1 below.

$$Average straightness = \frac{{\sum }_{k = 1}^{n} {L}_{k} / {V}_{sum , k}}{n} \qquad [ Equation 1 ]$$

In Equation 1, n is an integer of 10 to 100, Lₖ is a distance formed by connecting opposite endpoints of any single carbon nanotube in a straight line from an SEM image of the carbon nanotube, and V_{sum,k} means a sum of lengths of 5 to 20 two-dimensional vectors connected to each other along a shape of the single carbon nanotube when forming the above number of the two-dimensional vectors between the opposite endpoints of the single carbon nanotube from the SEM image.

The “average straightness” may be an average value of the straightness values of a plurality of single carbon nanotubes, and the straightness may be an indication of how similar the carbon nanotube is to a linear shape. The straightness may be represented as a ratio of the length Lₖ when the carbon nanotube has a linear shape to a value V_{sum,k} approximating the actual length of the carbon nanotube.

When the carbon nanotube has a linear shape, the length may be measured as the shortest distance between opposite endpoints of the carbon nanotube, for example, the length of the straight line formed by connecting the opposite endpoints of the carbon nanotube as observed from a scanning electron microscope (SEM) image of the carbon nanotube.

The value V_{sum,k} approximating the actual length of the carbon nanotube may mean the sum of the lengths of 5 to 20 two-dimensional vectors connected to each other along the shape when forming the above number of the two-dimensional vectors between the opposite endpoints of the carbon nanotube from the SEM image. The two-dimensional vectors may be connected starting from one endpoint of the carbon nanotube to the other endpoint. For example, the starting point of any vector among the two-dimensional vectors may be the same as one endpoint of the carbon nanotube or an ending point of another vector, and the ending point of any vector may be the same as the other end of the carbon nanotube or the starting point of the other vector.

In addition, the two-dimensional vectors may be linear vectors having a direction and a magnitude value, and the straightness may be calculated by using the sum of the magnitude values as a value approximating the actual length of the carbon nanotube.

The number of the two-dimensional vectors may be adjusted between 5 and 20, and the number and length thereof may vary depending on the shape of the carbon nanotube. For example, when the carbon nanotube comprises at least one bending part and a bending radius of the bending part is small, the number of two-dimensional vectors may be increased and the length may be decreased. For example, the length of the two-dimensional vectors may be 1 nm to 1,000 nm.

Accordingly, as the shape of the carbon nanotube is closer to the linear shape, it may have a value of straightness closer to 1, and when the shape of the carbon nanotube is the linear shape, the straightness may be 1. For example, the straightness of any carbon nanotube may be 0.6 or more, and an average value of the straightness may be 0.8 or more.

The average straightness may be an average value of the straightness values of 10 to 100 carbon nanotubes. For example, n may be an integer of 10 to 100 or 20 to 70.

According to some embodiments, the average straightness of the carbon nanotube may be 0.85 or more, 0.86 or more, 0.87 or more, 0.9 or more, 0.91 or more, 0.92 or more, 0.95 or more, or 0.96 or more, and may be 1 or less.

According to some embodiments, the carbon nanotube may comprise at least one bending part. For example, the carbon nanotube may comprise 1 to 10 bending parts. The “bending part” may mean a region where the carbon nanotube extends from one point and bends to another point in one rotational direction, and may be defined as different bending parts when the rotational direction is changed.

According to some embodiments, the length of the carbon nanotube may be about 3 μm to 12 μm.

Hereinafter, experimental examples including specific examples and comparative examples are proposed to facilitate understanding of the present disclosure. However, the following examples are only given for illustrating the present disclosure and are not intended to limit the appended claims. It will be apparent those skilled in the art that various alterations and modifications are possible within the scope and spirit of the present disclosure, and such alterations and modifications are duly included in the present disclosure.

### Preparative Example 1

A polyvinyl alcohol gel was prepared by mixing 8 g of polyvinyl alcohol (Sigma-Aldrich) and 40 g of deionized water while stirring at 90° C. for 30 minutes. An aluminum precursor solution was prepared by mixing 21 g of anhydrous aluminum nitrate, 7 g of glycine, and 12 g of deionized water while stirring for 30 minutes. The aluminum precursor solution was slowly input into the polyvinyl alcohol gel, followed by stirring for 30 minutes to prepare a mixture.

The mixture was placed in a muffle furnace, the temperature was increased at a rate of 5° C./min while passing air therethrough at a flow rate of 2 L/min, and was calcined for 5 hours after the temperature reached 600° C. to prepare a plate-shaped carrier.

### Preparative Example 2

A plate-shaped carrier was prepared in the same manner as in Preparative Example 1, except that the calcination temperature was changed to 700° C.

### Preparative Example 3

A plate-shaped carrier was prepared in the same manner as in Preparative Example 1, except that the calcination temperature was changed to 800° C.

### Preparative Example 4

A plate-shaped carrier was prepared in the same manner as in Preparative Example 1, except that the calcination temperature was changed to 900° C.

### Experimental Example: Analysis of Shape and Size of the Plate-Shaped Carrier

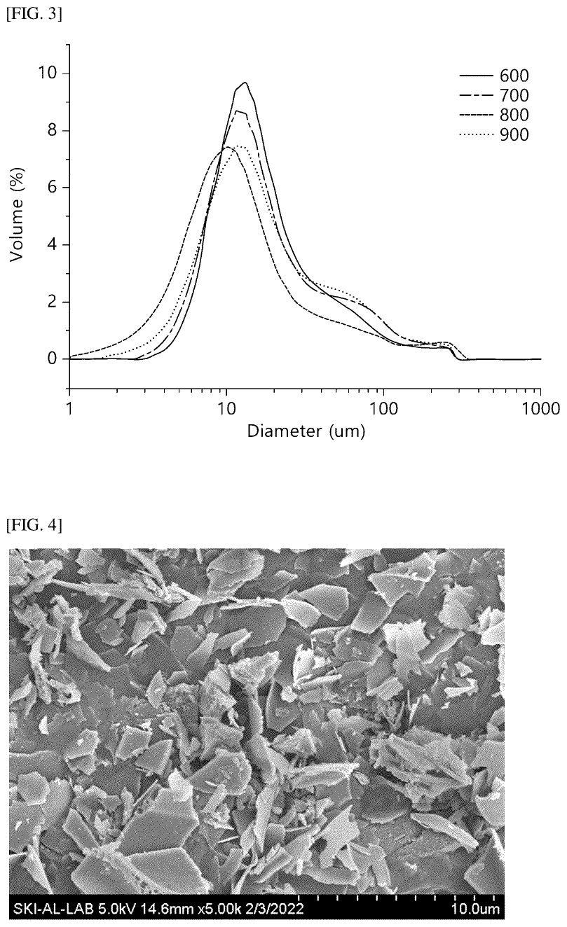

Particle sizes of the plate-shaped carriers of the preparative examples were analyzed using a laser particle size analyzer (Horiba/LA-950V2). FIG. 3 illustrates a particle size distribution graph of the plate-shaped carriers of the preparative examples. In the graph, the particle size distribution curves are represented as a volume-based frequency depending on the particle diameter (the maximum size in a surface direction). In addition, the median particle diameters (D50) of the plate-shaped carriers of the preparative examples measured by the particle size analyzer are shown in Table 1 below.

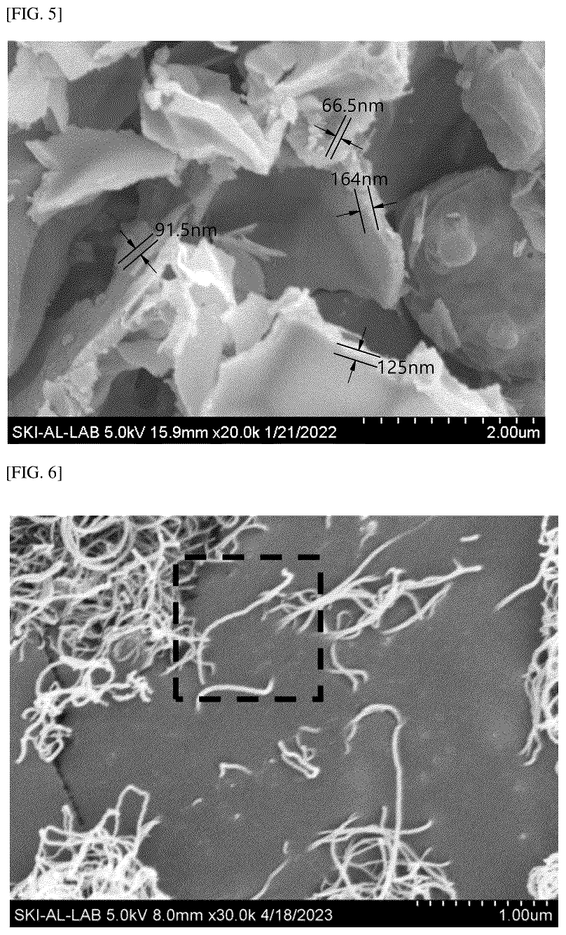

Scanning electron microscope (SEM) images of the plate-shaped carriers of the preparative examples were taken, and the thicknesses of about 50 random individual plate-shaped carriers were measured to calculate average thicknesses thereof. FIGS. 4 and 5 illustrate SEM images of the plate-shaped carrier of Preparative Example 1. Specifically, FIG. 5 is an SEM image of the plate-shaped carrier of Preparative Example 1 taken at a higher magnification than FIG. 4.

As shown in FIG. 5, the thicknesses of random plate-shaped carrier particles were measured, then the thickness measurements for about 50 particles were repeated in the same manner to calculate the average thicknesses of the plate-shaped carriers of the preparative examples, and results thereof are shown in Table 1 below.

In addition, BET surface areas of the plate-shaped carriers of the preparative examples were measured using a BET measuring device (Micromeritics/3Flex), and results thereof are also shown in Table 1 below.

TABLE 1

| | Median particle | Average thickness | BET surface area |
|---|---|---|---|
| Item | diameter (am) | (μm) | (m²/g) |
| Preparative | 24.4 | 0.1112 | 21.1 |
| Example 1 | | | |
| Preparative | 26.6 | 0.1219 | 9.2 |
| Example 2 | | | |
| Preparative | 21.9 | 0.1181 | 31.1 |
| Example 3 | | | |
| Preparative | 27.5 | 0.0970 | 49.0 |
| Example 4 | | | |

### Example 1

### (1) Preparation of Supported Catalyst

A solution was prepared by dissolving a cobalt precursor and a vanadium precursor in distilled water to satisfy a molar ratio of cobalt 80 mol % and vanadium 20 mol %. The plate-shaped carrier of Preparative Example 1 was input into the solution and calcined at 500° C. to prepare a supported catalyst including metal catalyst particles. The content of the metal catalyst particles was 16 wt. % based on the total weight of the supported catalyst.

### (2) Manufacturing of Carbon Nanotubes

1 g of the supported catalyst was input into a tube furnace, and a mixed gas including ethylene and hydrogen in a volume ratio of 1:1 was input at a rate of 2 L/min and allowed to react at a temperature of 700° C. for 30 minutes to obtain about 24.8 g of carbon nanotubes. The total weight of ethylene input for 30 minutes was 37.5 g.

### Example 2

A supported catalyst and carbon nanotubes were manufactured in the same manner as in Example 1, except that the plate-shaped carrier of Preparative Example 2 was used when preparing the supported catalyst. At this time, the yield of the carbon nanotubes was about 31.1 g.

### Example 3

A supported catalyst and carbon nanotubes were manufactured in the same manner as in Example 1, except that the plate-shaped carrier of Preparative Example 3 was used when preparing the supported catalyst. At this time, the yield of the carbon nanotubes was about 20.7 g.

### Example 4

A supported catalyst and carbon nanotubes were manufactured in the same manner as in Example 1, except that the plate-shaped carrier of Preparative Example 4 was used when preparing the supported catalyst. At this time, the yield of the carbon nanotubes was about 22.2 g.

### Example 5

A supported catalyst and carbon nanotubes were manufactured in the same manner as in Example 2, except that the supported catalyst was prepared so that the content of the metal catalyst particles was 20 wt. % based on the total weight of the supported catalyst. At this time, the yield of the carbon nanotubes was about 27.2 g.

### Example 6

A supported catalyst and carbon nanotubes were manufactured in the same manner as in Example 2, except that the supported catalyst was prepared so that the content of metal catalyst particles was 24 wt. % based on the total weight of the supported catalyst. At this time, the yield of the carbon nanotubes was about 28.0 g.

### Example 7

A supported catalyst and carbon nanotubes were manufactured in the same manner as in Example 2, except that the supported catalyst was prepared so that the content of metal catalyst particles was 12 wt. % based on the total weight of the supported catalyst. At this time, the yield of the carbon nanotubes was about 25.6 g.

### Example 8

A supported catalyst and carbon nanotubes were manufactured in the same manner as in Example 2, except that the cobalt precursor and vanadium precursor were used so as to satisfy the molar ratio of cobalt 70 mol % and vanadium 30 mol %. At this time, the yield of the carbon nanotubes was about 13.0 g.

### Example 9

A supported catalyst and carbon nanotubes were manufactured in the same manner as in Example 2, except that the cobalt precursor and vanadium precursor were used so as to satisfy the molar ratio of cobalt 85 mol % and vanadium 15 mol %. At this time, the yield of the carbon nanotubes was about 29.6 g.

### Example 10

A supported catalyst and carbon nanotubes were manufactured in the same manner as in Example 2, except that the cobalt precursor and vanadium precursor were used so as to satisfy the molar ratio the molar ratio of cobalt 90 mol % and vanadium 10 mol %. At this time, the yield of the carbon nanotubes was about 28.9 g.

### Comparative Example 1

A supported catalyst and carbon nanotubes were manufactured in the same manner as in Example 1, except that amorphous alumina particles (Puralox TH 100/150) were used as the carrier. At this time, the yield of carbon nanotubes was approximately 26.4 g.

### Comparative Example 2

The supported catalyst and carbon nanotubes were manufactured in the same manner as in Example 5, except that amorphous alumina particles (Puralox TH 100/150) were used as the carrier. At this time, the yield of carbon nanotubes was about 24.6 g.

Table 2 below shows type of the carriers, composition of metal catalyst particles, content of metal catalyst particles in the supported catalysts, and yield of the carbon nanotubes of the examples and comparative examples.

TABLE 2

| | | Metal | | | | | |
|---|---|---|---|---|---|---|---|
| | | catalyst | | | | | |
| | | particles | | | | | |
| | | | Content | | | | |
| | | | (Weight | | Carbon nanotube | | |
| | | | of total | | | Total | |
| | | Co:V | weight | Total | | weight | Carbon |
| | | composition | of | weight | | of | source |
| | | (molar | supported | of | | carbon | conversion |
| | | ratio | catalyst | catalyst | Yield | source | ratio |
| | Carrier | mol/mol) | %) | (g) | (g) | (g) | (%) |
| Example 1 | Preparative | 80:20 | 16 | 1.000 | 24.8 | 37.5 | 63.5 |
| | Example 1 | | | | | | |
| Example 2 | Preparative | 80:20 | 16 | 1.000 | 31.1 | 37.5 | 80.2 |
| | Example 2 | | | | | | |
| Example 3 | Preparative | 80:20 | 16 | 1.000 | 20.7 | 37.5 | 52.5 |
| | Example 3 | | | | | | |
| Example 4 | Preparative | 80:20 | 16 | 1.000 | 22.2 | 37.5 | 56.5 |
| | Example 4 | | | | | | |
| Example 5 | Preparative | 80:20 | 20 | 1.000 | 27.20 | 37.5 | 69.8 |
| | Example 2 | | | | | | |
| Example 6 | Preparative | 80:20 | 24 | 1.000 | 28.0 | 37.5 | 71.9 |
| | Example 2 | | | | | | |
| Example 7 | Preparative | 80:20 | 12 | 1.000 | 25.56 | 37.5 | 65.5 |
| | Example 2 | | | | | | |
| Example 8 | Preparative | 70:30 | 16 | 1.000 | 13.0 | 37.5 | 32.1 |
| | Example 2 | | | | | | |
| Example 9 | Preparative | 85:15 | 16 | 1.000 | 29.6 | 37.5 | 76.2 |
| | Example 2 | | | | | | |
| Example 10 | Preparative | 90:10 | 16 | 1.000 | 28.9 | 37.5 | 74.3 |
| | Example 2 | | | | | | |
| Comparative | Atypical | 80:20 | 16 | 1.000 | 26.4 | 37.5 | 67.8 |
| Example 1 | | | | | | | |
| Comparative | Atypical | 80:20 | 20 | 1.000 | 24.6 | 37.5 | 63.0 |
| Example 2 | | | | | | | |

### Experimental Example: Calculation and Evaluation of Average Straightness of the Carbon Nanotubes

After taking SEM images of the carbon nanotubes of the examples and comparative examples, the straightness and average value of a single carbon nanotube were calculated from the SEM images, respectively.

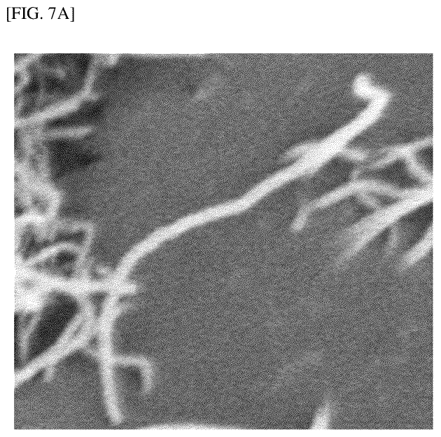

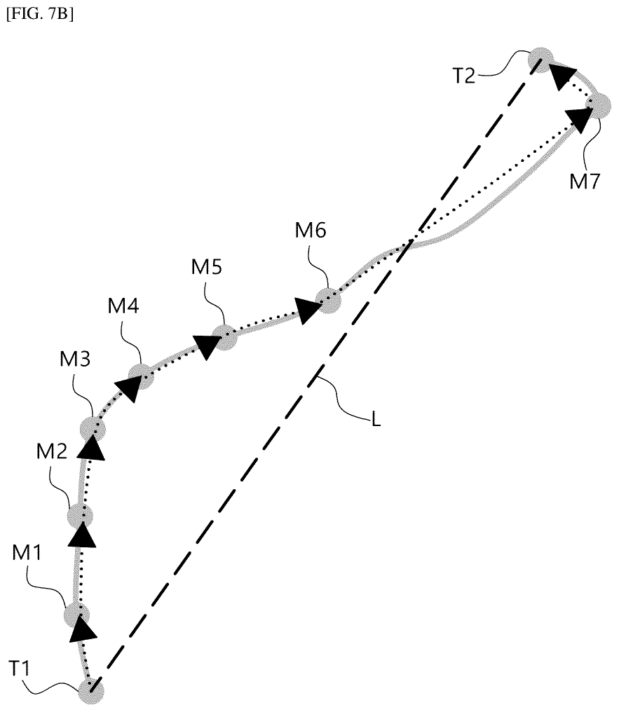

FIG. 6 illustrates an SEM image of the carbon nanotube of Example 2, and FIG. 7A illustrates an enlarged view of the dotted line portion in FIG. 6. Specifically, FIG. 7A is an SEM image of any single carbon nanotube.

FIG. 7B is a schematic view for describing a method for calculating the straightness of the carbon nanotube shown in FIG. 7A.

Referring to FIGS. 6, 7A and 7B, the length Lₖ of a straight line (solid line L in FIG. 7B) connecting opposite endpoints T1 and T2 of a single carbon nanotube was measured from the SEM image. In addition, when seven intermediate points (M1 to M7 in FIG. 7B) may be set between the opposite endpoints (T1 and T2 in FIG. 7B) of the single carbon nanotube, and eight vectors (dotted arrows in FIG. 7B) connecting points T1-M1, M1-M2, M2-M3, M3-M4, M4-M5, M5-M6, M6-M7 and M7-T2 are formed, the straightness Lₖ/V_{sum,k} was calculated using a value V_{sum,k} obtained by adding up the lengths of the respective vectors. In this way, the straightness for about (n=20 in Equation 1) single carbon nanotubes was calculated, and the average value thereof was calculated according to Equation 1.

By repeating the measurement and calculation in the same manner as described above, Lₖ, V_{sum,k}, straightness and average straightness of the carbon nanotubes of Example 2, Comparative Example 1 and Comparative Example 2 were determined, and results thereof are shown in Tables 3 to 5 below, respectively. In addition, the average straightness of the carbon nanotubes of the remaining examples and comparative examples was also calculated in the same manner, and results thereof are shown in Table 6 below.

TABLE 3
Example 2

| No | Straightness | Lₖ | V_{sum, k} |
|---|---|---|---|
| 1 | 0.916 | 10.144 | 11.072 |
| 2 | 0.991 | 7.276 | 7.341 |
| 3 | 0.983 | 6.229 | 6.336 |
| 4 | 0.979 | 5.25 | 5.36 |
| 5 | 1 | 8.172 | 8.172 |
| 6 | 1.002 | 4.703 | 4.693 |
| 7 | 0.973 | 4.027 | 4.14 |
| 8 | 0.997 | 4.484 | 4.496 |
| 9 | 0.973 | 8.402 | 8.636 |
| 10 | 0.949 | 5.752 | 6.06 |
| 11 | 0.982 | 8.731 | 8.896 |
| 12 | 0.985 | 11.242 | 11.411 |
| 13 | 1 | 7.897 | 7.897 |
| 14 | 0.992 | 10.656 | 10.737 |
| 15 | 0.962 | 10.581 | 11.003 |
| 16 | 0.985 | 5.155 | 5.235 |
| 17 | 0.992 | 6.366 | 6.417 |
| 18 | 0.948 | 4.41 | 4.653 |
| 19 | 0.915 | 5.215 | 5.7 |
| 20 | 0.842 | 5.577 | 6.622 |
| Average | 0.968 | | |
| straightness | | | |

TABLE 4
Comparative Example 1

| No | Straightness | Lₖ | V_{sum, k} |
|---|---|---|---|
| 1 | 0.886 | 6.66 | 7.517 |
| 2 | 0.669 | 4.152 | 6.206 |
| 3 | 0.799 | 3.916 | 4.899 |
| 4 | 0.661 | 5.423 | 8.208 |
| 5 | 0.887 | 2.765 | 3.118 |
| 6 | 0.456 | 1.993 | 4.372 |
| 7 | 0.843 | 3.226 | 3.825 |
| 8 | 0.394 | 1.613 | 4.089 |
| 9 | 0.52 | 3.329 | 6.408 |
| 10 | 0.832 | 2.673 | 3.213 |
| 11 | 0.604 | 2.804 | 4.641 |
| 12 | 0.305 | 1.178 | 3.868 |
| 13 | 0.267 | 1.619 | 6.073 |
| 14 | 0.861 | 6.531 | 7.581 |
| 15 | 0.494 | 3.615 | 7.324 |
| 16 | 0.424 | 2.146 | 5.066 |
| 17 | 0.277 | 2.174 | 7.841 |
| 18 | 0.535 | 3.709 | 6.926 |
| 19 | 0.829 | 4.584 | 5.533 |
| 20 | 0.886 | 5.424 | 6.125 |
| Average | 0.621 | | |
| straightness | | | |

TABLE 5
Comparative Example 2

| No | Straightness | Lₖ | V_{sum, k} |
|---|---|---|---|
| 1 | 0.779 | 2.182 | 2.801 |
| 2 | 0.954 | 2.376 | 2.492 |
| 3 | 0.827 | 4.566 | 5.518 |
| 4 | 0.903 | 7.045 | 7.799 |
| 5 | 0.633 | 2.367 | 3.737 |
| 6 | 0.924 | 5.357 | 5.799 |
| 7 | 0.285 | 3.34 | 11.725 |
| 8 | 0.925 | 4.505 | 4.87 |
| 9 | 0.902 | 3.56 | 3.945 |
| 10 | 0.756 | 5.262 | 6.957 |
| 11 | 0.592 | 3.25 | 5.488 |
| 12 | 0.327 | 3.602 | 11.022 |
| 13 | 0.787 | 4.835 | 6.146 |
| 14 | 0.329 | 1.784 | 5.418 |
| 15 | 0.818 | 2.122 | 2.594 |
| 16 | 0.92 | 3.72 | 4.045 |
| 17 | 0.815 | 4.298 | 5.276 |
| 18 | 0.852 | 3.642 | 4.275 |
| 19 | 0.965 | 4.817 | 4.993 |
| 20 | 0.907 | 2.849 | 3.142 |
| Average | 0.760 | | |
| straightness | | | |

TABLE 6

| | Average straightness |
|---|---|
| Example 1 | 0.820 |
| Example 2 | 0.968 |
| Example 3 | 0.864 |
| Example 4 | 0.869 |
| Example 5 | 0.871 |
| Example 6 | 0.881 |
| Example 7 | 0.865 |
| Example 8 | 0.836 |
| Example 9 | 0.91 |
| Example 10 | 0.922 |
| Comparative example 1 | 0.621 |
| Comparative example 2 | 0.760 |

Referring to Table 6, the carbon nanotubes of the examples had a high average straightness of 0.8 or more.

The carbon nanotubes of Comparative Examples 1 and 2 were manufactured using a supported catalyst including a spherical carrier. Accordingly, carbon nanotubes having a low straightness were manufactured.

The contents described above are merely an example of applying the principle of the present disclosure, and other configurations may be further included without departing from the scope of the present disclosure.

What is claimed is:

1. A supported catalyst for manufacturing carbon nanotubes comprising:
a plate-shaped carrier; and
a plurality of metal catalyst particles which are attached to a surface of the plate-shaped carrier and comprise cobalt and vanadium.

2. The supported catalyst for manufacturing carbon nanotubes according to claim 1, wherein the plate-shaped carrier comprises an aluminum oxide.

3. The supported catalyst for manufacturing carbon nanotubes according to claim 1, wherein the plate-shaped carrier has a thickness of 80 nm to 150 nm.

4. The supported catalyst for manufacturing carbon nanotubes according to claim 1, wherein the plate-shaped carrier has a median particle diameter (D50) of 15 μm to 30 μm.

5. The supported catalyst for manufacturing carbon nanotubes according to claim 1, wherein the plate-shaped carrier has a BET surface area of 5 m²/g to 50 m²/g.

6. The supported catalyst for manufacturing carbon nanotubes according to claim 1, wherein a content of the metal catalyst particles based on a total weight of the supported catalyst is 10% by weight to 30% by weight.

7. The supported catalyst for manufacturing carbon nanotubes according to claim 1, wherein a ratio of the vanadium content to the cobalt content based on a total moles of the metal catalyst particles is more than 0 and 0.5 or less.

8. The supported catalyst for manufacturing carbon nanotubes according to claim 1, wherein a ratio of the vanadium content to the cobalt content based on a total moles of the metal catalyst particles is 0.05 to 0.25.

9. A method for manufacturing carbon nanotubes, comprising:
preparing a mixture comprising a metal precursor and a polymer gel;
preparing a plate-shaped carrier by calcining the mixture;
preparing a supported catalyst by attaching a plurality of metal catalyst particles comprising cobalt and vanadium to a surface of the plate-shaped carrier; and
manufacturing carbon nanotubes by bringing the supported catalyst into contact with a carbon source.

10. The method for manufacturing carbon nanotubes according to claim 9, wherein the calcination is performed at a temperature of 500° C. to 1,000° C.

11. The method for manufacturing carbon nanotubes according to claim 9, wherein a carbon source conversion ratio defined as a percentage of a total weight of the carbon nanotube to a total weight of the carbon source is 50% to 90%.

12. Carbon nanotubes having an average straightness of 0.8 or more, which is represented by Equation 1 below:
$$Average straightness = \frac{{\sum }_{k = 1}^{n} {L}_{k} / {V}_{sum , k}}{n} \qquad [ Equation 1 ]$$
(in Equation 1, n is an integer of 10 to 100, Lₖ is a distance formed by connecting opposite endpoints of any single carbon nanotube in a straight line from an SEM image of the carbon nanotube, and V_{sum,k} is a sum of lengths of 5 to 20 two-dimensional vectors connected to each other along a shape of the single carbon nanotube when forming the respective 5 to 20 of the two-dimensional vectors between the opposite endpoints of the single carbon nanotube from the SEM image).

13. The carbon nanotubes according to claim 12, wherein the carbon nanotube has at least one bending part.

14. The carbon nanotubes according to claim 12, wherein the carbon nanotubes are prepared by a method comprising:
preparing a mixture comprising a metal precursor and a polymer gel;
preparing a plate-shaped carrier by calcining the mixture;
preparing a supported catalyst by attaching a plurality of metal catalyst particles comprising cobalt and vanadium to a surface of the plate-shaped carrier; and
manufacturing carbon nanotubes by bringing the supported catalyst into contact with a carbon source.
